(19) United States
(12) Patent Application Publication
(10) Pub. No.: US 2026/0122154 A1
(43) Pub. Date: Apr. 30, 2026

(54) SYSTEMS AND METHODS FOR SHARING METADATA USING PACKET ANNOTATIONS

(71) Applicant: NetScout Systems, Inc., Westford, MA (US)

(72) Inventors: Steinthor Bjarnason, Fjerdingby (NO); Brian St. Pierre, Ackworth, NH (US); Samantha DelaOssa, Bay Shore, NY (US)

(73) Assignee: NetScout Systems, Inc., Westford, MA (US)

(21) Appl. No.: 19/228,460

(22) Filed: Jun. 4, 2025

Related U.S. Application Data
(60) Provisional application No. 63/714,747, filed on Oct. 31, 2024.

(51) Int. Cl. H04L 69/22; H04L 67/146

(52) U.S. Cl. CPC H04L 69/22; H04L 67/146

(57) ABSTRACT

The present disclosure describes a system including one or more processors to store a plurality of inspection tools in memory; detect a plurality of data packet exchanges between pairs of network devices communicating across a communications network; store metadata generated from the plurality of data packet exchanges in respective records corresponding to the different data packet exchanges; receive a data packet transmitted from a first network device to a second network device across a communications network; extract session information from a header of the data packet; responsive to determining the extracted session information matches stored session information for a communication session, tag the data packet with an indication of an active session; and process the data packet based on the tag of the data packet indicating the active session.

### CROSS-REFERENCE TO RELATED APPLICATIONS

This application claims the benefit of priority to U.S. Provisional Application No. 63/714,747, filed Oct. 31, 2024, the entirety of which is incorporated by reference herein.

### BACKGROUND

State-exhaustion attacks are among the most used DDoS attack vectors today. These usually include unsolicited session control packets (e.g., TCP SYN, TCP ACK, TCK RST) which, when received by the destination under attack, can exhaust state tables or overwhelm the target, resulting in legitimate clients not being able to connect to destinations. Detecting these attacks can be done by looking for excessive amounts of state control packets but, due to differences in distinguishing those from legitimate client/server traffic, can result in false positives.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for sharing metadata using packet annotations, in accordance with an implementation;

FIG. 2 is an example method for sharing metadata using packet annotations, in accordance with an implementation;

FIG. 3 is an illustration of an example system for sharing metadata using packet annotations, in accordance with an implementation;

FIG. 4 is an example method for sharing metadata using packet annotations, in accordance with an implementation;

FIG. 5 is an example method for sharing metadata using packet annotations, in accordance with an implementation;

FIG. 6 is an example method for updating a database with network traffic data, in accordance with an implementation;

FIG. 7A is a block diagram depicting an implementation of a network environment including a client device in communication with a server device;

FIG. 7B is a block diagram depicting a cloud computing environment including a client device in communication with cloud service providers; and

FIG. 7C is a block diagram depicting an implementation of a computing device that can be used in connection with the systems depicted in FIGS. 1, 3, 7A, and 7B and the methods depicted in FIGS. 2 and 4-6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

State-exhaustion attacks have emerged as prominent DDoS vectors due to their effectiveness in overwhelming targeted systems. These attacks typically involve the transmission of unsolicited session control packets such as TCP SYN, TCP ACK, and TCP RST. When these packets flood a targeted destination, they aim to exhaust the system's state tables or resources, thereby rendering the service unavailable to legitimate users. The impact is severe, as it disrupts the normal operation of services and prevents genuine clients from establishing connections with the affected server.

Detecting state-exhaustion attacks involves monitoring for unusually high volumes of these session control packets. However, distinguishing malicious traffic from legitimate client-server interactions presents a significant challenge. This difficulty arises because legitimate traffic patterns can vary widely across different applications and services. As a result, detection mechanisms must strike a balance between sensitivity to potential threats and minimizing false positives, where legitimate traffic is incorrectly flagged as malicious. Effective detection often relies on sophisticated algorithms that analyze traffic behavior and patterns in real time, aiming to swiftly identify and mitigate the impact of such disruptive attacks on network infrastructure and service availability.

A computer implementing the systems and methods described herein can overcome the aforementioned technical deficiencies. The computer can do so using different inspection tools that tag monitored data packets with metadata regarding the communication sessions with which the data packets are a part. For example, the computer can store a plurality of inspection tools in memory. Each inspection tool can be configured to perform a different type of processing on data packets retrieved from the communications network. A first of the inspection tools can detect and store data packets and/or data regarding data packets of communication sessions between pairs of network devices communicating across a communications network in a database. In doing so, the first inspection tool can generate records in the database for different established sessions containing session information (e.g., protocol, source Internet Protocol (IP) address, destination IP address, source port, and/or destination port) for the respective sessions.

Subsequently, the first inspection tool can receive a data packet transmitted across the communication network. The first inspection tool can extract session information (e.g., protocol, source Internet Protocol (IP) address, destination IP address, source port, and/or destination port) from the data packet and compare the session information with corresponding session information of different records in the database. Responsive to identifying a match, the first inspection tool can tag the data packet with an indication that the data packet corresponds to an established session. The first inspection tool can pass the tagged data packet to a second inspection tool for further processing.

The second inspection tool may be configured to determine whether data packets correspond to a network attack (e.g., a state-exhaustion attack) or not. The second inspection tool may do so, for example, using various techniques and/or algorithms, such as by determining observed vectors from the results of a statistical analysis (e.g., comparing the observed vectors to known DDoS attack vectors, and checking if the percentage of observed vectors exceed a threshold percentage. The second inspection tool or a third inspection tool can select mitigation parameters associated with known DDoS attack vectors to use to mitigate the network attack. The computer can implement the selected mitigation measures itself or transmit a message to a network computer associated with the communications network to cause the network computer to implement the selected mitigation measures.

However, in cases in which data packets are tagged to indicate the data packets are a part of or are associated with established communication sessions, the second inspection tool may drop, discard, or ignore such data packets. The second inspection tool may do so because such tagged data packets are part of an established communication session. In some cases, the second inspection may drop, discard, or ignore the data packets in response to (e.g., further in response it) determining the active communication is trusted or is not a part of a network attack.

In some cases, the first inspection tool may tag data packets with other types of metadata. For instance, the first inspection tool can generate and/or tag data packets with an indication of whether the communication session has been authenticated, an indication of whether the data packet is within an expected time-to-live range, a reputation of the data packet (e.g., a reputation of a communications session of the data packet), and/or an indication of whether a source or destination of the data packet matches a list of known malicious computing devices. The first inspection tool may tag the data packets with such additional metadata in addition to or instead of the indication of whether the data packets correspond to an established communication session. The second inspection tool may use such metadata to determine whether the data packet corresponds to an attack.

Accordingly, by implementing the systems and methods described herein, the computer can enhance the analysis of suspicious network traffic. By dynamically tagging data packets with metadata of the communication sessions of which the data packets are a part with an inspection tool, other inspection tools can use the tagged metadata to reduce false positives of network attacks. For example, data packets which belong to established sessions can be ignored when looking for unsolicited session control packets, making the inspection more focused and less error-prone. The systems and methods can enhance analysis of state-exhaustion attacks, making it more focused and reducing false positives. In addition, the systems and methods can help identify other attack vectors.

### A. Metadata Sharing System for Attack Detection and Mitigation

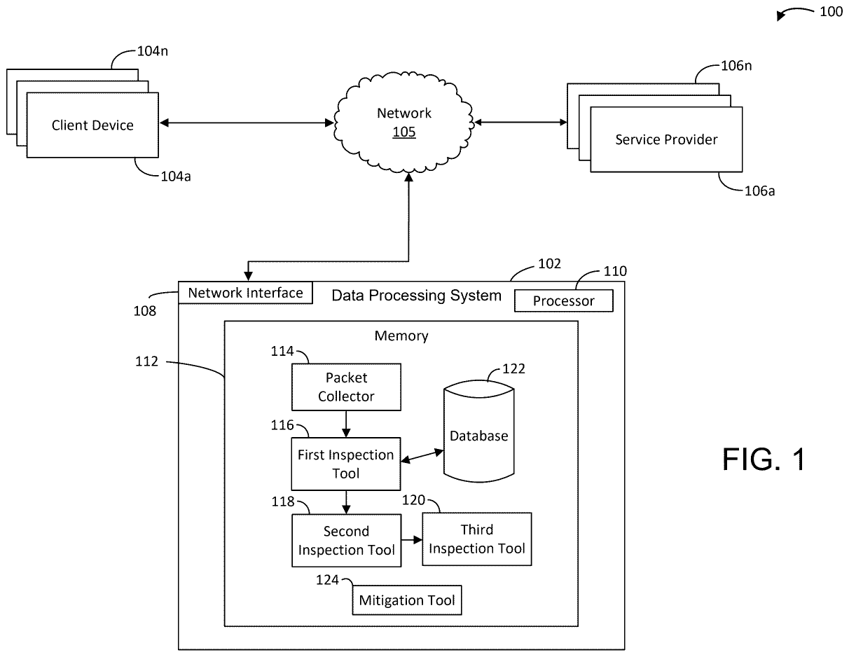

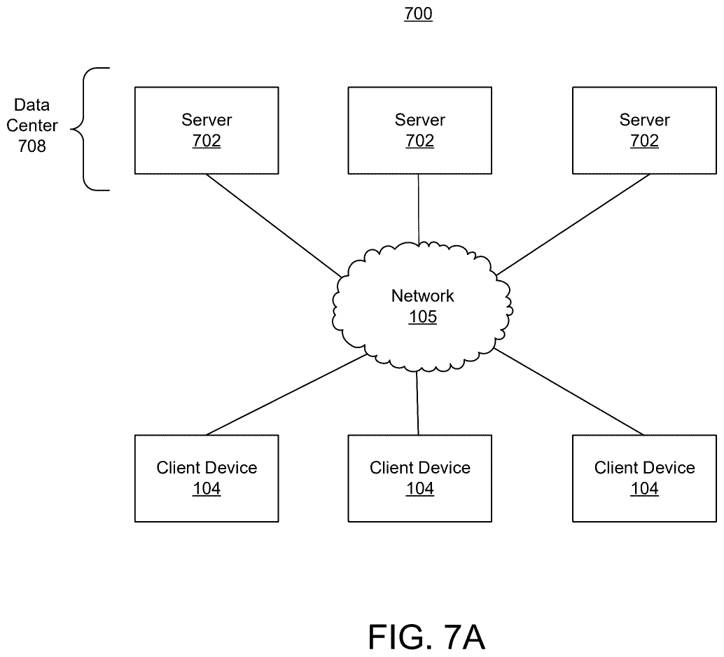

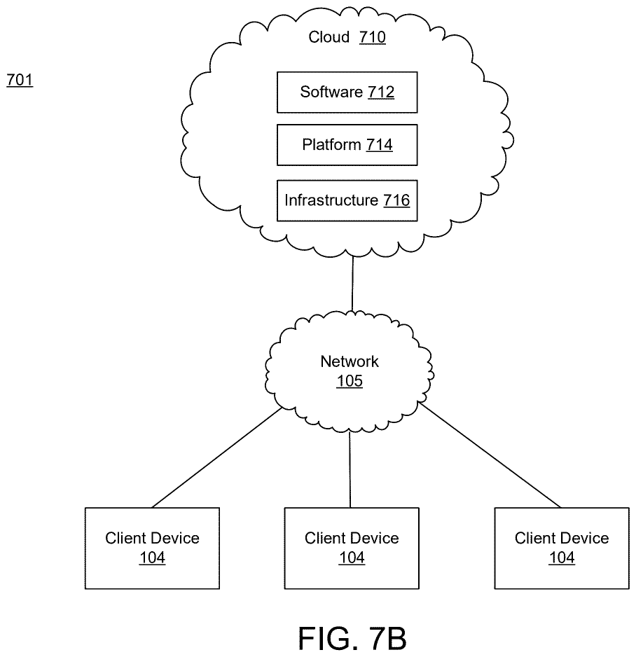

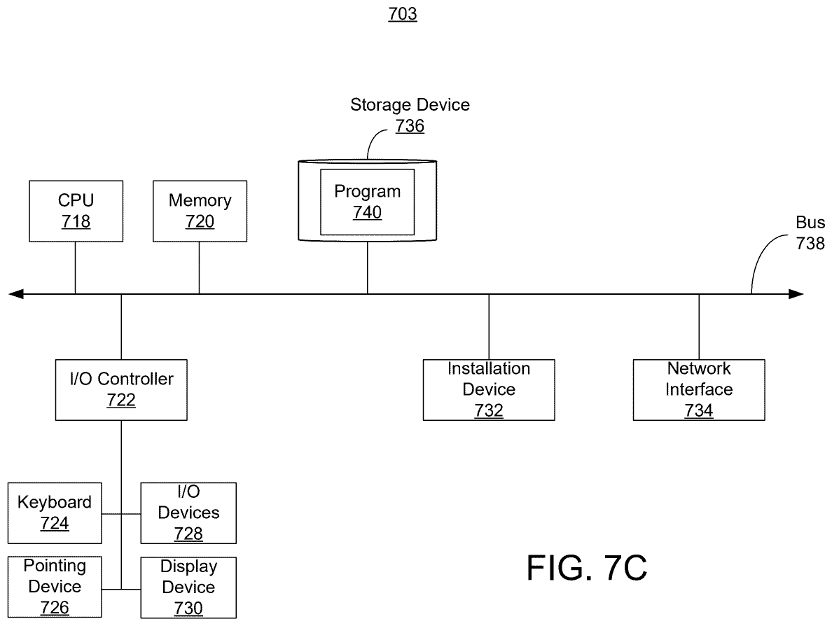

FIG. 1 illustrates an example system 100 for sharing metadata using packet annotations, in some embodiments. The system 100 may provide improved network monitoring of a communications network to detect attacks on the communications network. In brief overview, the system 100 can include a data processing system 102 that receives and/or stores data packets transmitted via a network 105 between client devices 104a-n (hereinafter client device 104 or client devices 104) and service providers 106a-n (hereinafter service provider 106 or service providers 106). The service providers 106 can each include a set of one or more servers 702, depicted in FIG. 7A, or a data center 708. The data processing system 102 can generate a database or data structure by storing session information for different communication sessions in the database, storing the session information for different communication sessions in different records in the database. A first inspection tool can subsequently identify a data packet and extract session information from the data packet. The first inspection tool can compare the extracted session information with session information of records in the database. The first inspection tool can identify a record containing matching session information to the data packet and tag the data packet to indicate the data packet is a part of an established session. A second inspection tool or a different tool can process the tagged data packet based on the tag, such as by discarding the data packet based on the tag or using the tag to determine whether the data packet is associated with a network attack.

The data processing system 102, the client devices 104, and/or the service providers 106 can each include or execute on one or more processors or computing devices (e.g., the computing device 703 depicted in FIG. 7C) and/or communicate via the network 105. The network 105 can be a communications network and can include computer networks such as the Internet, local, wide, metro, or other area networks, intranets, satellite networks, and other communication networks such as voice or data mobile telephone networks. The network 105 can be used to access information resources such as web pages, websites, domain names, or uniform resource locators that can be presented, output, rendered, or displayed on at least one computing device (e.g., client device 104), such as a laptop, desktop, tablet, personal digital assistant, smartphone, portable computers, or speaker. In some embodiments, the network 105 may be or include a self-organizing network that implements a machine learning model to automatically adjust connections and configurations of network elements of the network 105 to optimize network connections (e.g., minimize latency, reduce dropped calls, increase data rate, increase quality of service, etc.).

Each of the data processing system 102, the client devices 104, and/or the service providers 106 can include or utilize at least one processing unit or other logic device such as a programmable logic array engine, or module configured to communicate with one another or other resources or databases. The components of the data processing system 102, the client devices 104, and/or the service providers 106 can be separate components or a single component. The system 100 and its components can include hardware elements, such as one or more processors, logic devices, or circuits.

Still referring to FIG. 1, and in further detail, the system 100 can include the service providers 106. The service providers 106 may each be or include servers or computers configured to transmit or provide services across the network 105 to the client devices 104. The service provider 106 can be or include host computing devices. The service providers 106 may transmit or provide such services upon receiving requests for the services from any of the client devices 104. The term “service” as used herein includes the supplying or providing of information over a network, and is also referred to as a communications network service. Examples of services include 5G broadband services, any voice, data, or video service provided over a network, smart-grid network, digital telephone service, cellular service, Internet protocol television (IPTV), etc.

The client devices 104 can include or execute applications to receive data from the service providers 106. For example, a client device 104 may execute a video application upon receiving a user input selection that causes the client device 104 to open the video application on the display. Responsive to executing the video application, a service provider 106 associated with the video application may stream a requested video to the client device 104 in a communication session. In another example, a client device 104 may execute a video game application. Responsive to executing the video game application, a service provider 106 associated with the video game application may provide data for the video game application to the client device 104. In another example, the client device 104 can execute a browser application that enables a user to browse the Internet. The client devices 104 can be host computing devices, in some cases.

A client device 104 can be located or deployed at any geographic location in the network environment depicted in FIG. 1. A client device 104 can be deployed, for example, at a geographic location where a typical user using the client device 104 would seek to connect to a network (e.g., access a browser or another application that requires communication across a network). For example, a user can use a client device 104 to access the Internet at home, as a passenger in a car, while riding a bus, in the park, at work, while eating at a restaurant, or in any other environment. The client device 104 can be deployed at a separate site, such as an availability zone managed by a public cloud provider (e.g., a cloud 710 depicted in FIG. 7B). If the client device 104 is deployed in a cloud 710, the client device 104 can include or be referred to as a virtual client device or virtual machine. In the event the client device 104 is deployed in a cloud 710, the packets exchanged between the client device 104 and the service providers 106 can still be retrieved by network monitoring equipment or the data processing system 102 from the network 105. In some cases, the data processing system 102 and/or the client devices 104 can be deployed in the cloud 710 on the same computing host in an infrastructure 716 (described below with respect to FIG. 7B).

The data processing system 102 may comprise one or more processors that are configured to receive data packets of communication between the client devices 104 and/or the service providers 106 across the network 105. The data processing system 102 may comprise a network interface 108, a processor 110, and/or memory 112. The data processing system 102 may communicate with network monitoring equipment (e.g., a probe monitoring data packets transmitted across a mobile communications network), in some embodiments. The processor 110 may be or include an ASIC, one or more FPGAs, a DSP, circuits containing one or more processing components, circuitry for supporting a microprocessor, a group of processing components, or other suitable electronic processing components. In some embodiments, the processor 110 may execute computer code or modules (e.g., executable code, object code, source code, script code, machine code, etc.) stored in the memory 112 to facilitate the operations described herein. The memory 112 may be any volatile or non-volatile computer-readable storage medium capable of storing data or computer code.

The memory 112 can store a packet collector 114, a first inspection tool 116, a second inspection tool 118, a third inspection tool 120, a database 122, and/or a mitigation tool 124. The components 114-124 can operate to generate and detect network tags using inspection tools that process the data packets in sequence, tagging the data packets for each processing. The components 114-124 can tag the data packets to indicate whether the data packets correspond to established communication sessions or not and, in some cases, with additional metadata regarding the communication sessions. The components 114-124 can then use those tags to determine whether to continue processing the data packets and/or whether the data packets are a part of a network attack. In some cases, the components 114-124 can mitigate a detected network attack, such as by throttling or blocking network traffic or transmitting a message to another computing device or system to cause the other computing device or system to throttle or block the network traffic. In this way, the components 114-124 can use tags to detect network attacks (e.g., state-exhaustion attacks and other types of attacks), such as by detecting attacks without updating a state table with data packets from attacks.

The packet collector 114 can be or include instructions that, when executed by one or more processors, cause the one or more processors to collect data packets transmitted across the network 105. The packet collector 114 can be an application programming interface, in some cases. For example, during a monitoring period, the data processing system 102 can receive or intercept data packets that are transmitted between devices across the network 105, such as between one or more of the client devices 104 and one or more of the service providers 106. The packet collector 114 can receive the data packets and pass the data packets to the first inspection tool 116.

The first inspection tool 116 can be or include instructions that, when executed by one or more processors, cause the one or more processors to update the database 122 (e.g., a relational database or table) based on data packets that are collected by the packet collector 114. For instance, over time, the first inspection tool 116 can receive data packets for different communication sessions from the packet collector 114. The first inspection tool 116 can extract session information or tuples (e.g., protocol, source Internet Protocol (IP) address, destination IP address, source port, and/or destination port information) from the data packets (e.g., from the headers of the data packets). The first inspection tool 116 can generate records for the individual communication sessions in the database 122 that each include session information for a different communication session. The first inspection tool 116 can generate such records in real time by inserting the session information into the records for the respective communication sessions. In cases in which the first inspection tool 116 determines a record has already been generated for a communication session, the first inspection tool 116 may discard the data packet. The first inspection tool 116 can repeat this process over time to maintain a record of different communication sessions in the database 122.

In some cases, the first inspection tool 116 can include metadata for the different communication sessions in the records for the communication sessions. For example, the first inspection tool 116 can include data such as an expected time-to-live value or expected range of time-to-live values in a record for a communication session. The first inspection tool 116 can determine or generate such values or ranges by identifying the time-to-live values of one or more data packets that the first inspection tool 116 identifies for the communication session and including the identified values in the record. The range of time-to-live values can be or include the lowest time-to-live value and the highest time-to-live value that the first inspection tool 116 identifies for a data packet. The first inspection tool 116 can update the range (e.g., expand the range) for the communication session over time as the first inspection tool 116 identifies data packets for the communication session with higher or lower time-to-live values than the boundaries in the current range. The first inspection tool 116 can similarly update the time-to-live ranges for any number of communication sessions.

Another example of metadata that the first inspection tool 116 can store in the records for communication sessions can include indications of whether the communication session has been authenticated. The first inspection tool 116 can store such information in the records responsive to receiving indications that the respective communication sessions have been authenticated, for example.

In some cases, the first inspection tool 116 can store information regarding devices in the database 122. For example, the first inspection tool 116 can store a list of devices that have been identified as part of a botnet in the database 122. In another example, the first inspection tool 116 can store values (e.g., numerical values or modifiers) indicating the reputation of different devices. The first inspection tool 116 can store such values with identifiers of the devices such as the IP addresses of the devices.

The first inspection tool 116 can use the records in the database 122 to facilitate detecting network attacks. For example, the first inspection tool 116 can receive a data packet (e.g., a network packet) from the packet collector 114. The first inspection tool 116 can extract session information from the data packet. The first inspection tool 116 can compare the session information to session information in the different records of the database 122. Responsive to determining there is not a record that contains matching session information to the data packet, the first inspection tool 116 can insert a flag into the data packet indicating the data packet is not associated with an active session.

However, responsive to determining there is a matching record, the data processing system can insert a flag in the data packet indicating the data packet is a part of an established session and/or retrieve different metadata from the record, such as an indication of whether the communication session to which the data packet belongs has been authenticated. In some cases, the data processing system can determine further metadata for the data packet, such as by identifying the time-to-live of the data packet, determining if the time-to-live of the data packet is within the time-to-live range in the record for the communications session, and inserting a flag indicating a result of the comparison.

In some cases, the first inspection tool 116 can use the stored information for the devices to generate metadata for the data packet. For instance, the first inspection tool 116 can compare the session information for the data packet to the lists of reputations and known botnets to determine if the source and/or destination for the data packet are associated with (e.g., identified on) either list. The first inspection tool 116 can determine whether there is a match based on either comparison and insert identifications of the determinations in the metadata for the data packet.

The first inspection tool 116 can pass the annotated data packet to the second inspection tool 118. The first inspection tool 116 can pass the annotated data packet to the second inspection tool 118 using a file exchange (e.g., by attaching the metadata to the data packet using a structured format, such as PcapNG), using real-time transport (e.g., sending the data packet to the second inspection tool 118 using the underlying network while transporting the metadata for the data packet to the second inspection tool 118 using out-of-band channel), and/or using packet manipulation (e.g., by adding the metadata to the data packet itself and transporting the updated data packet to the second inspection tool 118).

In some cases, the first inspection tool 116 may only update the database 122 based on new data packets in a peacetime mode and only use the database 122 to detect network attacks or attach metadata to data packets when an attack is detected. The first inspection tool 116 can be configured to operate in the different modes based on user inputs, based on determinations by the data processing system 102, and/or based on messages from other computing devices monitoring the network 105.

The second inspection tool 118 can be or include instructions that, when executed by one or more processors, cause the one or more processors to process data packets based on metadata included in or received with the data packets. For example, second inspection tool 118 can process the tagged data packet that the second inspection tool 118 receives from the first inspection tool 116. In doing so, the second inspection tool 118 can identify any tags of metadata of the data packet. Responsive to detecting a tag indicating the data packet is associated with an active session, the second inspection tool 118 can drop or ignore the data packet from further processing. The second inspection tool 118 can do so, for example, because the second inspection tool 118 is configured to detect network attacks, and a tag indicating a data packet is a part of an active or established session can be an indication that the tagged data packet is not a part of a network attack while a tag indicating the data packet is not a part of an active or established session can be an indication that the tagged data packet is a part of network attack.

In cases in which the tag indicates the tagged data packet is not a part of an active or established session, or otherwise in cases in which the tagged data packet is tagged with additional data or metadata, the second inspection tool 118 can determine the data packet is a data packet of an attack or perform other processing to determine whether the data packet is a part of a network attack. For example, the second inspection tool 118 can identify one or more of: an indication of whether the authentication session is active or established, an indication of whether the communication session of the data packet has been authenticated, an indication of whether the data packet is within an expected time-to-live range, a reputation of the communication session of the data packet, and/or an indication of whether a source or destination of the communication session matches a list of known malicious computing devices. Each such indication can be a factor in determining whether the data packet is a part of a network attack. The second inspection tool 118 can increase or decrease a likelihood or confidence score of whether the data packet is a part of the network attack based on the indications (e.g., increase the likelihood if the data packet is outside of the expected time-to-live range or decrease the likelihood if the data packet is inside the expected time-to-live range, and similar for other types of indications). The second inspection tool 118 can compare the likelihood or confidences score to a threshold. Responsive to determining the likelihood or confidence exceeds or satisfies the threshold, the second inspection tool 118 can determine the data packet is a data packet of a network attack.

In some cases, the data processing system 102 can attach metadata to data packets using multiple inspection tools. For example, the third inspection tool 120 can be or include instructions that, when executed by one or more processors, cause the one or more processors to process data packets based on metadata included in or received with the data packets. The second inspection tool 118 or the third inspection tool 120 can be configured to attach metadata to data packets, such as the metadata described above by performing any of the processes described above. The different inspection tools 116, 118, and/or 120 can attach different metadata to data packets and pass the metadata and data packets to each other as described herein. In doing so, the inspection tools 116, 118, and/or 120 can update the data packets with new metadata or otherwise update files or data structures associated with the data packets with the new metadata generated or retrieved by the respective inspection tools 116, 118, and/or 120. The data processing system 102 can include any number of such inspection tools that can each be configured to generate and/or attach specific types of metadata to data packets.

In some cases, the data processing system 102 can store a mitigation tool 124. The mitigation tool 124 can be or include instructions that, when executed by one or more processors, cause the one or more processors to mitigate network attacks. The mitigation tool 124 can mitigate network attacks by throttling, blocking, or otherwise inhibiting data packets transmitted by or transmitted to devices identified by one of the inspection tools 118 or 120 as corresponding to or participating in a network attack (e.g., from the data packet determined to correspond to the network attack). The mitigation tool 124 can identify the offending devices and mitigate the data packets transmitted to and/or from the devices. In some cases, the mitigation tool 124 can transmit a message to another computing device managing or monitoring the network 105 identifying the devices (e.g., through session information of the devices, such as the IP addresses of the devices) on which to perform such mitigation measures. Thus, the data processing system can use the mitigation tool 124 to protect the network 105.

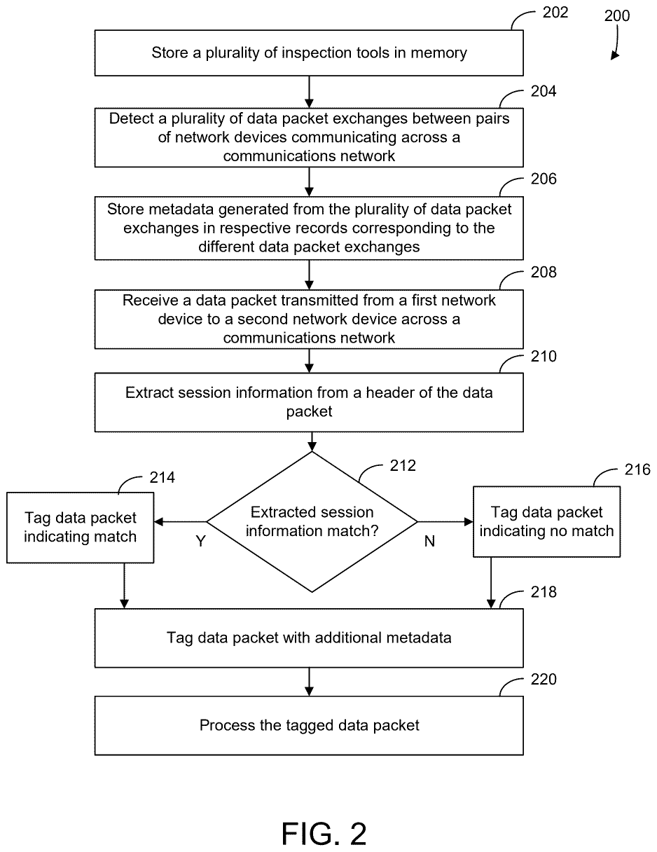

FIG. 2 is an example method 200 for sharing metadata using packet annotations, in accordance with an implementation. One or more operations of the method 200 can be performed by all or any combination or permutation of the components of the system 100, shown and described with reference to FIG. 1, such as the data processing system 102. The operations of the method 200 can be performed in any order and may be performed with more or fewer operations.

At an operation 202, the data processing system stores a plurality of inspection tools in memory. The inspection tools may be or correspond to separate sets of instructions and/or protocols that are each configured to perform a different type of processing action on data packets transmitted across and/or collected from a communications network. The inspection tools can each be configured to operate on the same computing device, may be distributed across different computing devices (e.g., different inspection tools can be stored and/or processed on different computing devices), and/or a combination of being stored on the same computing device and/or different computing devices (e.g., multiple inspection tools may be stored on individual computing devices across a network of multiple computing devices).

The data processing system can be configured to directly receive or collect data packets from the communications network. The data packets can be data packets of data packet exchanges between pairs of network devices that each represent a communication session between one network device and another network device across the communications network. The data processing system can receive data packets as a computing device in the middle of the communication sessions or by receiving data packets from another computing device in the middle of the communication sessions.

A first inspection tool of the plurality of inspection tools may be configured to collect or monitor the data packets from the communications network and/or analyze the collected data packets. The first inspection tool can store the data packets in a database and/or generate metadata, such as by generating an indication of whether the communication session of the data packet has been authenticated, generating an indication of whether the data packet is within an expected time-to-live range, generating a reputation of the data packet, and/or generating an indication of whether a source or destination of the data packet matches a list of known malicious computing devices. The first inspection tool can generate such metadata for data packets and store the metadata in the database. The first inspection tool can additionally tag data packets with the metadata. The first inspection tool can pass the tagged data packets to a second inspection tool of the plurality of inspection tools in memory.

The second inspection tool may be configured to process data packets based on the tags of the data packets generated by the first inspection tool. The second inspection tool can generate further tags for the data packets and/or operate to determine whether data packets are associated with a network attack, such as a state-exhaustion attack or a DDoS attack. In some cases, the second inspection tool can be configured to generate further metadata for the data packet (e.g., metadata for the communication session of the data packet). The metadata can include an indication of whether the data packet is associated with a network attack. The second inspection tool can tag the generated further metadata to the data packet. The second inspection tool can pass the tagged (e.g., secondly tagged) data packet to a third inspection tool for further processing.

The data processing system can pass tagged data packets between any number of inspection tools in memory. Each inspection tool can process data of the tagged data packets, generate new metadata regarding the communication sessions of the data packets, tag the data packets with the generated new metadata, and pass the data packets to another inspection tool. In some cases, the inspection tools can be “nodes” of a directed acyclic graph (DAG), as described in U.S. patent application Ser. No. 18/741,712, filed Jun. 12, 2024, the entirety of which is incorporated by reference herein. In such cases, the data processing can execute the inspection tools in an order indicated in the DAG to analyze data packets, detect attacks, and implement mitigation measures (e.g., data packet throttling, blocking, redirection, etc.). The data processing system can implement the mitigation measures itself or by generating and transmitting a message to another computing device to implement the mitigation measures.

At an operation 204, the data processing system detects a plurality of data packet exchanges of network devices communicating across a communications network. The data processing system can do so using the first inspection tool. The data processing system can detect the plurality of data packet exchanges from the communications network. The data processing system can detect the plurality of data packet exchanges by receiving data packets of the data packet exchanges transmitted across the data processing system and storing data packets of the data packet exchanges in a database.

For example, the data processing system can identify different data packets that are transmitted across the communications network. In doing so, the data processing system can identify or extract session information from the data packets (e.g., from the headers of the data packets). The session information can include protocol, source Internet Protocol (IP) address, destination IP address, source port, and/or destination port information, for example. The data processing system can extract such session information from individual data packets and store the session information in the database.

The data processing system can store records for individual data packet exchanges using the extracted session information. For instance, the data processing system can detect different data packet exchanges by identifying data packets with unique session information. To do so, the data processing system can store records for individual data packet exchanges that the data processing system detects across the communications network. The data processing system can extract session information from a data packet and compare the extracted session information to the records. Responsive to determining a match with session information in a record, the data processing system can store the data packet (e.g., a copy of the data packet) or data of the data packet (e.g., metadata or other information of the data packet) in the record and/or drop or discard the data packet (e.g., without storing any further data in the record). However, responsive to determining there is not a match, the data processing system can generate and/or store a new record in the database for the data packet exchange that contains the non-matching session information. The data processing system can similarly detect data packet exchanges and/or store records for data packet exchanges in the database over time to generate a record for the data packet exchanges (e.g., established communication sessions between pairs of network devices).

In some cases, the data processing system may only store new records for data packet exchanges in a monitoring mode. The data processing system may be in the monitoring mode in a “peace” time in which there is not an attack or a threat of an attack on the communications network. The data processing system may change to a mitigation mode and stop storing new records responsive to a user input, detecting an attack on the communications network, and/or receiving a message from another computing device indicating an attack on the communications network.

At an operation 206, the data processing system stores metadata generated from the plurality of data packet exchanges. The data processing systems can store the metadata generated from the data packet exchanges using the first inspection tool. For example, the first inspection tool can generate metadata such as indications of active communication sessions, indications of whether the communication sessions have been authenticated, indications of whether the data packets are within an expected time-to-live range, reputations of the communication sessions or data packets, and/or indications of whether sources or destinations of the communication session matches a list of known malicious computing devices.

At an operation 208, the data processing system receives a data packet. The data packet may be a data packet transmitted across the communications network. The data packet may be transmitted from a network device to a server or another network device across a communications network (e.g., network 105). The data processing system may receive the data packet using the first inspection tool. The data processing system may be stored in or on the network and may receive data packets as they are transmitted across the network from the client device to the server.

At an operation 210, the data processing system extracts session information from the data packet. The data processing system can extract the session information using the first inspection tool. The data processing system can extract the session information by identifying protocol, source IP address, destination IP address, source port, and/or destination port information, for example.

At an operation 212, the data processing system determines whether there is a match between the extracted session information and session information in a record stored in the database. The data processing system can do so using the first inspection tool. For example, the data processing system can compare the extracted session information of the data packet with the session information stored in records in the database. In performing the comparison, the data processing system can determine whether there is an exact match (e.g., each value of the extracted session information is the same or identical a corresponding value in a record in the database). In some cases, the data processing system can determine there is a match if extracted session information matches session information in a record and the record contains an indication of an active or established session.

Responsive to determining there is a match, at operation 214, the data processing system can tag the data packet to indicate the data packet is a part of, is associated with, or corresponds with an active or established session. The data processing system can do so using the first inspection tool. The tag can be an identifier associated with an active or established session. The data processing system can tag the data packet by labeling the data packet with the tag. However, responsive to determining there is not a match (e.g., not an exact match), at operation 216, the data processing system can similarly tag the data packet with an indicator or identifier indicating that the data packet is not associated with an active or established session.

In some embodiments, at operation 218, the data processing system can tag the data packet with additional metadata. The data processing system can do so using the first inspection tool. The additional metadata can include data such as an indication of whether the communication session of the data packet has been authenticated, an indication of whether the data packet is within an expected time-to-live range, a reputation of the communication session of the data packet, and/or an indication of whether a source or destination of the communication session matches a list of known malicious computing devices. The data processing system can generate or determine such additional metadata by retrieving the metadata from a record (if any) of the communication session of the data packet and/or by generating the metadata from the data packet itself. For example, the data processing system can identify the TTL value from the header of the data packet and compare the TTL value with an expected TTL value in the record for the communication session of the data packet to determine if they match or are within a threshold of each other. The first inspection tool can pass the tagged data packet to the second inspection tool.

The first inspection tool can tag and pass data packets to the second inspection tool in one of a few manners. For example, the first inspection tool can generate a file containing both the data packet and the associated packet metadata. The first inspection tool can store the metadata for the packet in the file in a structured format (e.g., in a table including attribute-value pairs). The first inspection tool can then pass (e.g., make available) the file to the second inspection tool. In another example, the first inspection tool can use real-time transport to pass the data packet and tagged metadata to the second inspection tool In doing so the first inspection tool can transport the data packet to the second inspection tool using the underlying network (e.g., an internal communications network or a first channel) while the metadata for the packet is passed out-of-band (e.g., in a second channel) to the second inspection tool. The first inspection tool can do so, for example, using a message bus such as Kafka. In another example, the first inspection tool can use packet manipulation. In doing so, the first inspection tool can add the metadata to the data packet itself. The first inspection tool can, for example, do so using IP Option fields where each metadata element is represented as an IP Option. The first inspection tool can then pass the enhanced or enriched data packet to the second inspection tool for further processing. In another example, the first inspection tool can add per-packet annotations containing the metadata in a file format such as PcapNG, which can allow each packet in the recording to carry, store, or contain an annotation.

At operation 220, the data processing system processes the tagged data packet. The data processing system can process the tagged data packet using the second inspection tool. For example, the second inspection tool can identify any tags of metadata of the data packet. Responsive to detecting a tag indicating the data packet is associated with an active session, the second inspection tool can drop or ignore the data packet from further processing. The second inspection tool can do so, for example, because the second inspection tool is configured to detect network attacks, and a tag indicating a data packet is a part of an active or established session can be an indication that the tagged data packet is not a part of a network attack while a tag indicating the data packet is not a part of an active or established session can be an indication that the tagged data packet is a part of network attack.

In cases in which the tag indicates the tagged data packet is not a part of an active or established session, or otherwise in cases in which the tagged data packet is tagged with additional data or metadata, the data processing system can determine the data packet is a data packet of an attack or perform other processing to determine whether the data packet is a part of a network attack. For example, the data processing system can identify one or more of: an indication of whether authentication session is active or established, an indication of whether the communication session of the data packet has been authenticated, an indication of whether the data packet is within an expected time-to-live range, a reputation of the communication session of the data packet, and/or an indication of whether a source or destination of the communication session matches a list of known malicious computing devices. Each such indication can be a factor in determining whether the data packet is a part of a network attack. The data processing system can increase or decrease a likelihood or confidence score of whether the data packet is a part of the network attack based on the indications (e.g., increase the likelihood if the data packet is outside of the expected time-to-live range or decrease the likelihood if the data packet is inside the expected time-to-live range, and similar for other types of indications). The data processing system can compare the likelihood or confidences score to a threshold. Responsive to determining the likelihood or confidence exceeds or satisfies the threshold, the data processing system can determine the data packet is a data packet of a network attack.

In some cases, the data processing system can employ multiple inspection tools to annotate data packets with metadata. For example, instead of using the second inspection tool to detect attacks, the second inspection tool can generate further metadata (e.g., second metadata) for the data packet or the second inspection tool can tag the data packet with an indication of the determination of whether the data packet is a part of or is associated with a network attack. The second inspection tool can pass the tagged data packet to a third inspection tool for further processing. The second inspection tool can pass the tagged data packet to the third inspection tool in one of the manners described above in which the first inspection tool passed the tagged data packet to the second inspection tool.

In one example, using a first network traffic inspection tool (e.g., first inspection tool), the data processing system can track and store in memory metadata about active clients and their communication sessions. The first inspection tool can then attach the metadata to the network packets when they are transported to other tools and devices, making it possible to easily share the metadata.

For instance, the first network inspection tool can store information about active sessions in memory. When exporting network packets to a second inspection tool, the packets are annotated with a flag that states whether they belong to an active session or not. The second inspection tool can then use this flag to disregard network packets belonging to an active session from analysis, making it possible to focus the inspection on the remaining packets and reduce the processing load on the second inspection tool to detect and mitigate network attacks.

In cases in which the second inspection tool or another inspection tool (e.g., the third inspection tool) determines the data packet is a part of a network attack, the data processing system can execute a mitigation tool to mitigate the network attack and/or transmit a message to a computing device managing the communications network to mitigate the network attack. For example, responsive to determining the data packet is a part of the network attack, the data processing system can inhibit transmission of data packets of the communication session of the data packet by throttling or blocking data packet packets of the communication session. In some cases, the data processing system can transmit a message to a computing device managing the communications network to cause the computing device to similarly inhibit transmission of data packets of the communication session.

The data processing system can perform the method 200 for any number of data packets and/or any number of times. In some embodiments, the data processing system may only perform the operations 204 and 206 in a monitoring mode and only perform the operations 208-220 in a mitigation mode.

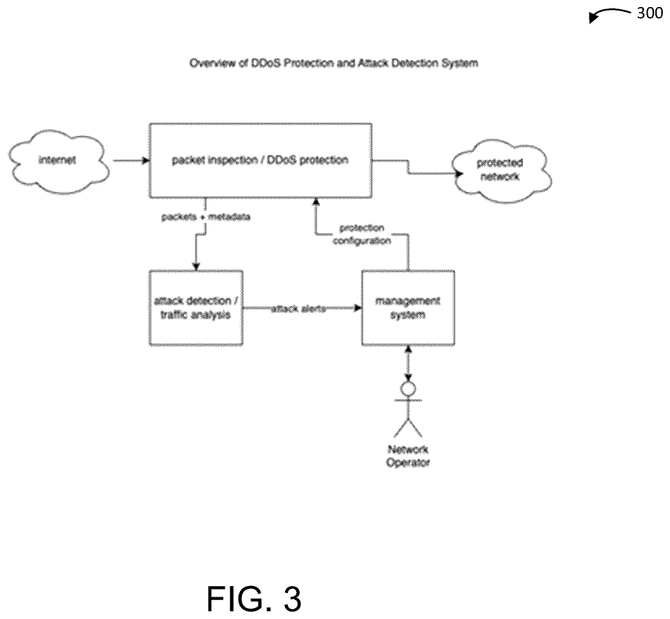

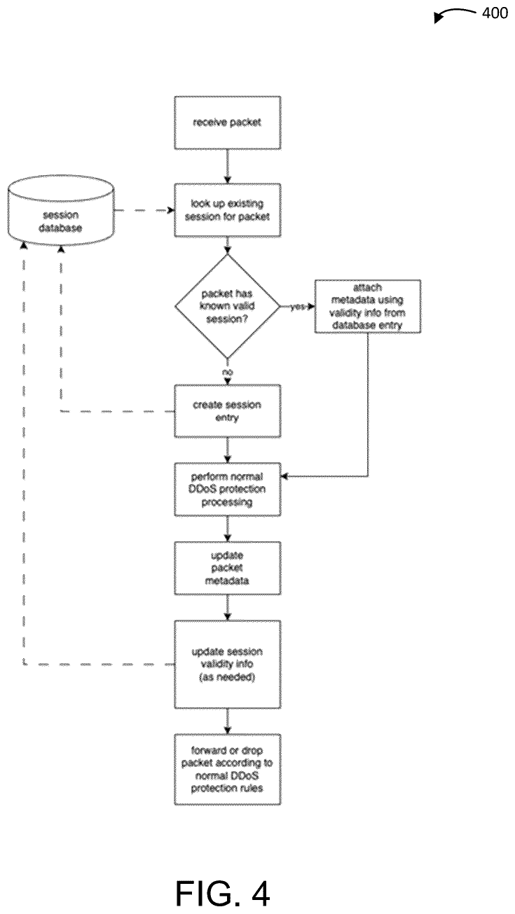

FIG. 3 is an illustration of an example system 300 for sharing metadata between inspection tools using packet annotations, in accordance with an implementation. In the system 300, a DDoS protection system can analyze packets that arrive from the Internet. Packets are inspected by the DDoS protection system and forwarded/dropped according to the active protection configuration. A selection of packets is extracted, and relevant metadata is attached to the packets, such as in the manner shown and described with reference to FIG. 4. The packets are associated with or are annotated with metadata and then transported to a secondary inspection process which performs further attack detection/traffic analysis, such as in the manner shown and described with reference to FIG. 4. If attacks are detected by the secondary inspection process, alerts are generated and sent to the management system. The management system will then modify the protection configuration accordingly and send it to the DDoS protection system which will then mitigate the newly detected attacks.

FIG. 4 is an example method 400 for sharing metadata using packet annotations, in accordance with an implementation. FIG. 4 illustrates how the normal packet processing procedure is modified to generate and attach metadata to packets that are inspected as part of a packet processing system, for example, a DDoS protection system (e.g., the DDoS protection system of FIG. 3 or the data processing system 102 of FIG. 1). The system receives a packet for inspection. All packets handled by the inspection system may have a small memory area in which per-packet metadata can be stored. The system looks up the packet's 5-tuple (protocol, source IP, destination IP, source port, destination port) in a session database. If a session exists, information associated with the session is attached to the packet's metadata. For example, this information can include an indication that this session was established normally, or that the session is likely to have been spoofed. If a session does not exist in the database, a new entry is created. Then normal packet processing is performed. For example, this may be DDoS protection and may include deciding whether to drop packets according to a set of rules. As part of that processing, changes to the packet's metadata may be made. For example, the packet may help confirm that a session should be marked as valid, or that the packet's TTL is in a valid range, or the geographic region from which the packet was sent may be recorded in the metadata. Finally, the packet is disposed of according to the normal processing rules. For example, it may be forwarded to its ultimate destination, or it may be dropped, or it may be encapsulated for forwarding in a tunnel.

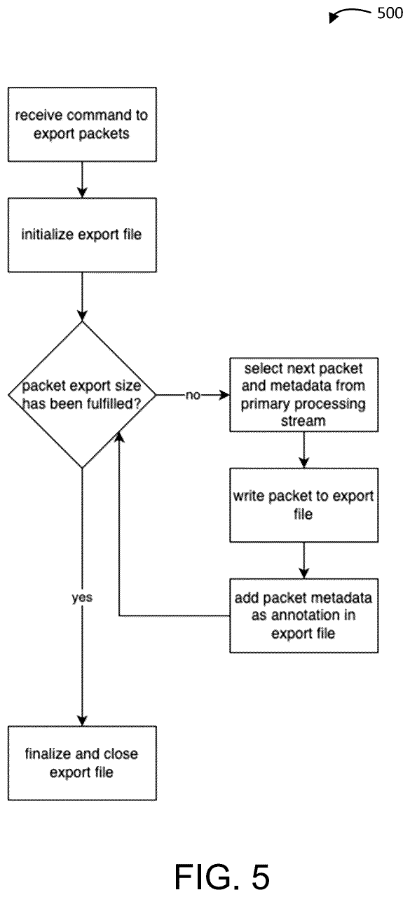

FIG. 5 is an example method 500 for sharing metadata using packet annotations, in accordance with an implementation. FIG. 5 illustrates the process by which a packet export is created. The packet inspection system receives a command to perform a packet export. This command includes the number of packets that are desired for export. An export file is created and initialized. The following steps are repeated until the number of desired packets have been written to the file. The next packet from the processing stream is selected; the packet's metadata is accessible to the export procedure. The packet is written to the export file, according to the format of the export file, for example, PcapNG. The packet's metadata is written to the export file as a per-packet annotation, for example, according to the PcapNG format. When the desired number of packets have been written, the file is finalized (for example, by adding any end-of-file records or markers that are required by the format) and closed. At this point the export file is available to be read by another process.

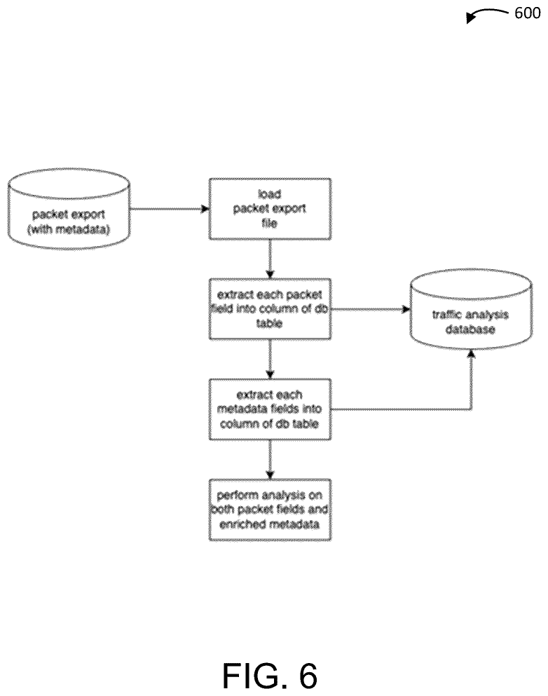

FIG. 6 is an example method for updating a database with network traffic data, in accordance with an implementation. FIG. 6 illustrates that the secondary process processes the exported packets containing associated metadata and performs attack detection analysis. Each packet is loaded, and relevant fields stored in a traffic analysis database. The metadata fields are also extracted and each field is stored as a separate column in the traffic analysis database. For example, the packet export storage consists of multiple network packets stored in PcapNG format. Each network packet has a set of PcapNG annotations containing zero, one or more metadata fields. In this example, the traffic analysis database consists of 2 fields, “tcp.flags” and “InSession”. When a packet is read from the packet export storage, the packet is checked if it is a TCP packet. If it is not a TCP packet, it is skipped from further analysis. If the packet is a TCP packet, the value from packet “tcp.flags” field is copied into the “tcp.flags” field in the traffic analysis database. If the packet has a metadata field called “InSession,” its value is copied into the “InSession” field in the traffic analysis database. If the packet does not have this metadata field, the value of NULL is stored in the “InSession” field.

After loading all the packets from the packet export storage, the traffic analysis database will now contain a set of values and metadata copied from the packets in packet export storage. As explained in U.S. Pat. No. 11,770,405, filed Sep. 10, 2020, the entirety of which is incorporated by reference herein, the attack detection analysis of the packets in the traffic analysis database can be performed by performing statistical analysis of the packets, as described in U.S. Pat. No. 10,469,528, filed Feb. 27, 2017, the entirety of which is incorporated by reference herein, determining observed vectors from the results of the statistical analysis, comparing the observed vectors to known DDoS attack vectors, checking if the percentage of observed vectors exceed a threshold percentage, and selecting mitigation parameters associated with known DDoS attack vectors.

If any attack vectors are identified, the attack vector information and associated mitigation parameters are then combined into attack alerts and sent to the management system, such as in the manner shown and described with reference to FIG. 3.

Using the previous example, the statistical analysis process can identify a single observed vector for TCP ACK packets:

| | | |
|---|---|---|
| Vector #1 | tcp.flags == 0x10 | percentage = 16% |

This matches a known DDoS attack vector called “TCP ACK flooding” which has condition “tcp.flags==0x10.” In this case, the observed percentage of packets (16%) exceeds the threshold percentage (5%) and an alert with corresponding mitigation parameters would be generated.

Using this method approach, it is possible to take advantage of the metadata field “InSession.” To do so, the list of known DDoS attack vectors for TCP flooding attacks would be modified to contain an extra condition for the “InSession” metadata field. For example, the known attack vector “TCP ACK flooding” attack vector would be modified to have two conditions: “tcp.flags==0x10 and InSession==FALSE”. During the packet analysis, two observed vectors would be identified. These observed vectors contain two fields, “tcp.flags” and “InSession”:

| | | | |
|---|---|---|---|
| Vector #1 | tcp.flags == 0x10 | InSession == True | percentage = 15% |
| Vector #2 | tcp.flags == 0x10 | InSession == False | percentage = 1% |

When comparing these observed vectors against the known DDoS attack vectors, a match would be found for “TCP ACK flooding” but as the observed percentage (1%) is less than the threshold (5%), an alert would not be generated.

Advantageously, by implementing the systems and methods described herein, a computer can dynamically pass metadata between inspection tools and/or devices. Additionally, the computer can perform a more focused analysis and reduce false positives.

At least one aspect is directed to a system that includes one or more processors coupled with memory, the memory storing executable instructions that, when executed by the one or more processors, cause the one or more processors to store a plurality of inspection tools in memory, each inspection tool configured to perform a different type of processing action on data packets transmitted across a communications network; detect a plurality of data packet exchanges between pairs of network devices communicating across a communications network, each of the plurality of data packet exchanges representing a communication session between one network device and another network device across the communication network; store, using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges; receive a data packet transmitted from a first network device to a second network device across a communications network; extract, using the first inspection tool, session information from a header of the data packet; responsive to determining the extracted session information matches stored session information for a communication session, tag, using the first inspection tool, the data packet with an indication of an active session; and process, using a second inspection tool of the plurality of inspection tools, the data packet based on the tag of the data packet indicating the active session.

In some embodiments, the instructions cause the one or more processors to pass, using the first inspection tool, the tagged data packet to the second inspection tool. In some embodiments, the instructions can cause the one or more processors to pass, using the first inspection tool, the tagged data packet to the second inspection tool by generating, using the first inspection tool, the tagged data packet containing the data packet, the data packet tagged in a structured format, and sending the generated tagged data packet to the second inspection tool; transporting, using the first inspection tool, the data packet to the second inspection tool using a first channel and the indication of the active session using a second channel; or generating, using the first inspection tool, an updated data packet containing data of the data packet and the indication of the active session and sending the generated tagged data packet to the second inspection tool.

In some embodiments, the instructions cause the one or more processors to tag, using the first inspection tool, the data packet with additional metadata regarding the communication session, the additional metadata comprising one or more of an indication of whether the communication session has been authenticated, an indication of whether the data packet is within an expected time-to-live range, a reputation of the data packet, or an indication of whether a source or destination of the data packet matches a list of known malicious computing devices.

In some embodiments, the instructions can cause the one or more processors to process the tagged data packet by processing, using the second inspection tool, the data packet based on the indication of the active session and the additional metadata. In some embodiments, the instructions can cause the one or more processors to detect, using the second inspection tool, a network attack based on the tag indicating the active session and the additional metadata. In some embodiments, the instructions can cause the one or more processors to inhibit network traffic of data packets of the communication session responsive to detecting the network attack. In some embodiments, the instructions can cause the one or more processors to process the data packet based on the tag of the data packet indicating the active session by discarding, using the second inspection tool, the data packet responsive to determining the data packet is tagged with the indication of the active session. In some embodiments, the instructions can cause the one or more processors to generate, using the second inspection tool, second metadata regarding the communication session; and tag, using the second inspection tool, the data packet with the second metadata. In some embodiments, the instructions can cause the one or more processors to process, using a third inspection tool of the plurality of inspection tools, the tagged data packet based on the indication of the active session and the second metadata.

In at least one aspect, a system can include one or more processors coupled with memory, the memory storing executable instructions that, when executed by the one or more processors, cause the one or more processors to store a plurality of inspection tools in memory, each inspection tool configured to perform a different type of processing action on data packets transmitted across a communications network; detect a plurality of data packet exchanges between pairs of network devices communicating across a communications network, each of the plurality of data packet exchanges representing a communication session between one network device and another network device across the communication network; store, using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges; receive a data packet transmitted from a first network device to a second network device across a communications network; extract, using the first inspection tool, session information from a header of the data packet; responsive to determining the extracted session information does not match a stored session information for a communication session, tag, using the first inspection tool, the data packet with an indication that the data packet is not associated with an active session; and process, using a second inspection tool of the plurality of inspection tools, the data packet based on the tag of the data packet indicating the data packet is not associated with an active session.

In some embodiments, the instructions cause the one or more processors to pass, using the first inspection tool, the tagged data packet to the second inspection tool. In some embodiments, the instructions cause the one or more processors to pass, using the first inspection tool, the tagged data packet to the second inspection tool by generating, using the first inspection tool, the tagged data packet containing the data packet, the data packet tagged in a structured format, and sending the generated tagged data packet to the second inspection tool; transporting, using the first inspection tool, the data packet to the second inspection tool using a first channel and the indication of the active session using a second channel; or generating, using the first inspection tool, an updated data packet containing data of the data packet and the indication of the active session and sending the generated tagged data packet to the second inspection tool.

In some embodiments, the instructions cause the one or more processors to process the data packet based on the tag of the data packet indicating the data packet is not associated with an active session by discarding, using the second inspection tool, the data packet responsive to determining the data packet is tagged with the indication that the data packet is not associated with an active session.

In another aspect, a method can include storing, by one or more processors, a plurality of inspection tools in memory, each inspection tool configured to perform a different type of processing action on data packets transmitted across a communications network; detecting, by the one or more processors, a plurality of data packet exchanges between pairs of network devices communicating across a communications network, each of the plurality of data packet exchanges representing a communication session between one network device and another network device across the communication network; storing, by the one or more processors using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges; receiving, by the one or more processors, a data packet transmitted from a first network device to a second network device across a communications network; extracting, by the one or more processors using the first inspection tool, session information from a header of the data packet; responsive to determining the extracted session information matches stored session information for a communication session, tagging, by the one or more processors using the first inspection tool, the data packet with an indication of an active session; and processing, by the one or more processors using a second inspection tool of the plurality of inspection tools, the data packet based on the tag of the data packet indicating the active session.

In some embodiments, the method can include passing, by the one or more processors using the first inspection tool, the tagged data packet to the second inspection tool. In some embodiments, the method can include passing, by the one or more processors using the first inspection tool, the tagged data packet to the second inspection tool by generating, by the one or more processors using the first inspection tool, the tagged data packet containing the data packet, the data packet tagged in a structured format, and sending the generated tagged data packet to the second inspection tool; transporting, by the one or more processors using the first inspection tool, the data packet to the second inspection tool using a first channel and the indication of the active session using a second channel; or generating, by the one or more processors using the first inspection tool, an updated data packet containing data of the data packet and the indication of the active session and sending the generated tagged data packet to the second inspection tool.

In some embodiments, the method can include tagging, by the one or more processors using the first inspection tool, the data packet with additional metadata regarding the communication session, the additional metadata comprising one or more of an indication of whether the communication session has been authenticated, an indication of whether the data packet is within an expected time-to-live range, a reputation of the data packet, or an indication of whether a source or destination of the data packet matches a list of known malicious computing devices.

In some embodiments, the method can include processing the tagged data packet can include processing, by the one or more processors using the second inspection tool, the data packet based on the indication of the active session and the additional metadata. In some embodiments, the method can include detecting, by the one or more processors using the second inspection tool, a network attack based on the tag indicating the active session and the additional metadata.

### B. Computing Environment

FIG. 7A depicts an example network environment that can be used in connection with the methods and systems described herein. In brief overview, the network environment 700 includes one or more client devices 104 (also generally referred to as clients, client node, client machines, client computers, client computing devices, endpoints, or endpoint nodes) in communication with one or more servers 702 (also generally referred to as servers, nodes, or remote machine) via one or more networks 105. In some embodiments, a client 104 has the capacity to function as both a client node seeking access to resources provided by a server and as a server providing access to hosted resources for other client devices 104.

Although FIG. 7A shows a network 105 between the client devices 104 and the servers 702, the client devices 104 and the servers 702 can be on the same network 105. In embodiments, there are multiple networks 105 between the client devices 104 and the servers 702. The network 105 can include multiple networks such as a private network and a public network. The network 105 can include multiple private networks.

The network 105 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA. In some embodiments, different types of data can be transmitted via different links and standards. In other embodiments, the same types of data can be transmitted via different links and standards.

The network 105 can be any type and/or form of network. The geographical scope of the network 105 can vary widely and the network 105 can be a body area network (BAN), a personal area network (PAN), a local-area network (LAN), e.g., Intranet, a metropolitan area network (MAN), a wide area network (WAN), or the Internet. The topology of the network 105 can be of any form and can include, e.g., any of the following: point-to-point, bus, star, ring, mesh, or tree. The network 105 can be an overlay network which is virtual and sits on top of one or more layers of other networks 105. The network 105 can be of any such network topology as known to those ordinarily skilled in the art capable of supporting the operations described herein. The network 105 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 105 can be a type of a broadcast network, a telecommunications network, a data communication network, or a computer network.

The network environment 700 can include multiple, logically grouped servers 702. The logical group of servers can be referred to as a data center 708 (or server farm or machine farm). In embodiments, the servers 702 can be geographically dispersed. The data center 708 can be administered as a single entity or different entities. The data center 708 can include multiple data centers 708 that can be geographically dispersed. The servers 702 within each data center 708 can be homogeneous or heterogeneous (e.g., one or more of the servers 702 or machines 702 can operate according to one type of operating system platform (e.g., WINDOWS NT, manufactured by Microsoft Corp. of Redmond, Washington), while one or more of the other servers 702 can operate on according to another type of operating system platform (e.g., Unix, Linux, or Mac OS X)). The servers 702 of each data center 708 do not need to be physically proximate to another server 702 in the same machine farm 708. Thus, the group of servers 702 logically grouped as a data center 708 can be interconnected using a network. Management of the data center 708 can be de-centralized. For example, one or more servers 702 can comprise components, subsystems and modules to support one or more management services for the data center 708.

Server 702 can be a file server, application server, web server, proxy server, appliance, network appliance, gateway, gateway server, virtualization server, deployment server, SSL VPN server, or firewall. In embodiments, the server 702 can be referred to as a remote machine or a node. Multiple nodes can be in the path between any two communicating servers.

FIG. 7B illustrates an example cloud computing environment. A cloud computing environment 701 can provide client 104 with one or more resources provided by a network environment. The cloud computing environment 701 can include one or more client devices 104, in communication with the cloud 710 over one or more networks 105. Client devices 104 can include, e.g., thick clients, thin clients, and zero clients. A thick client can provide at least some functionality even when disconnected from the cloud 710 or servers 702. A thin client or a zero client can depend on the connection to the cloud 710 or server 702 to provide functionality. A zero client can depend on the cloud 710 or other networks 105 or servers 702 to retrieve operating system data for the client device. The cloud 710 can include back end platforms, e.g., servers 702, storage, server farms or data centers.

The cloud 710 can be public, private, or hybrid. Public clouds can include public servers 702 that are maintained by third parties to the client devices 104 or the owners of the clients. The servers 702 can be located off-site in remote geographical locations as disclosed above or otherwise. Public clouds can be connected to the servers 702 over a public network. Private clouds can include private servers 702 that are physically maintained by client devices 104 or owners of clients. Private clouds can be connected to the servers 702 over a private network 105. Hybrid clouds 708 can include both the private and public networks 105 and servers 702.

The cloud 710 can also include a cloud-based delivery, e.g., Software as a Service (SaaS) 712, Platform as a Service (PaaS) 714, and the Infrastructure as a Service (IaaS) 716. IaaS can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, e.g., storage, networking, servers or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client devices 104 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 104 and server 702 can be deployed as and/or executed on any type and form of computing device, e.g., a computer, network device or appliance capable of communicating on any type and form of network and performing the operations described herein.

FIG. 7C depicts block diagrams of a computing device 703 useful for practicing an embodiment of the client 104 or a server 702. As shown in FIG. 7C, each computing device 703 can include a central processing unit 718, and a main memory unit 720. As shown in FIG. 7C, a computing device 703 can include one or more of a storage device 736, an installation device 732, a network interface 734, an I/O controller 722, a display device 730, a keyboard 724 or a pointing device 726, e.g., a mouse. The storage device 736 can include, without limitation, a program 740, such as an operating system, software, or software associated with system 100.

The central processing unit 718 is any logic circuitry that responds to and processes instructions fetched from the main memory unit 720. The central processing unit 718 can be provided by a microprocessor unit, e.g.: those manufactured by Intel Corporation of Mountain View, California. The computing device 703 can be based on any of these processors, or any other processor capable of operating as described herein. The central processing unit 718 can utilize instruction level parallelism, thread level parallelism, different levels of cache, and multi-core processors. A multi-core processor can include two or more processing units on a single computing component.

Main memory unit 720 can include one or more memory chips capable of storing data and allowing any storage location to be directly accessed by the microprocessor 718. Main memory unit 720 can be volatile and faster than storage 736 memory. Main memory units 720 can be Dynamic random access memory (DRAM) or any variants, including static random access memory (SRAM). The memory 720 or the storage 736 can be non-volatile; e.g., non-volatile read access memory (NVRAM). The memory 720 can be based on any type of memory chip, or any other available memory chips. In the example depicted in FIG. 7C, the processor 718 can communicate with memory 720 via a system bus 738.

A wide variety of I/O devices 728 can be present in the computing device 703. Input devices 728 can include keyboards, mice, trackpads, trackballs, touchpads, touch mice, multi-touch touchpads and touch mice, microphones, multi-array microphones, drawing tablets, cameras, or other sensors. Output devices can include video displays, graphical displays, speakers, headphones, or printers.

I/O devices 728 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 728, display devices 730 or group of devices can be augmented reality devices. The I/O devices can be controlled by an I/O controller 722 as shown in FIG. 7C. The I/O controller 722 can control one or more I/O devices, such as, e.g., a keyboard 724 and a pointing device 726, e.g., a mouse or optical pen. Furthermore, an I/O device can also provide storage and/or an installation device 732 for the computing device 703. In embodiments, the computing device 703 can provide USB connections (not shown) to receive handheld USB storage devices. In embodiments, an I/O device 728 can be a bridge between the system bus 738 and an external communication bus, e.g., a USB bus, a SCSI bus, a FireWire bus, an Ethernet bus, a Gigabit Ethernet bus, a Fibre Channel bus, or a Thunderbolt bus.

In embodiments, display devices 730 can be connected to I/O controller 722. Display devices can include, e.g., liquid crystal displays (LCD), electronic papers (e-ink) displays, flexile displays, light emitting diode displays (LED), or other types of displays. In some embodiments, display devices 730 or the corresponding I/O controllers 722 can be controlled through or have hardware support for OPENGL or DIRECTX API or other graphics libraries. Any of the I/O devices 728 and/or the I/O controller 722 can include any type and/or form of suitable hardware, software, or combination of hardware and software to support, enable or provide for the connection and use of one or more display devices 730 by the computing device 703. For example, the computing device 703 can include any type and/or form of video adapter, video card, driver, and/or library to interface, communicate, connect or otherwise use the display devices 730. In embodiments, a video adapter can include multiple connectors to interface to multiple display devices 730.

The computing device 703 can include a storage device 736 (e.g., one or more hard disk drives or redundant arrays of independent disks) for storing an operating system or other related software, and for storing application software programs 740 such as any program related to the systems, methods, components, modules, elements, or functions depicted in FIGS. 1-6. Examples of storage device 736 include, e.g., hard disk drive (HDD); optical drive including CD drive, DVD drive, or BLU-RAY drive; solid-state drive (SSD); USB flash drive; or any other device suitable for storing data. Storage devices 736 can include multiple volatile and non-volatile memories, including, e.g., solid state hybrid drives that combine hard disks with solid state cache. Storage devices 736 can be non-volatile, mutable, or read-only. Storage devices 736 can be internal and connect to the computing device 703 via a bus 738. Storage device 736 can be external and connect to the computing device 703 via an I/O device 730 that provides an external bus. Storage device 736 can connect to the computing device 703 via the network interface 734 over a network 105. Some client devices 104 may not require a non-volatile storage device 736 and can be thin clients or zero client devices 104. Some storage devices 736 can be used as an installation device 732 and can be suitable for installing software and programs.

The computing device 703 can include a network interface 734 to interface to the network 105 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The computing device 703 can communicate with other computing devices 703 via any type and/or form of gateway or tunneling protocol, e.g., Secure Socket Layer (SSL) or Transport Layer Security (TLS), QUIC protocol, or the Citrix Gateway Protocol manufactured by Citrix Systems, Inc. of Ft. Lauderdale, Florida. The network interface 734 can include a built-in network adapter, network interface card, PCMCIA network card, EXPRESSCARD network card, card bus network adapter, wireless network adapter, USB network adapter, modem or any other device suitable for interfacing the computing device 703 to any type of network capable of communication and performing the operations described herein.

A computing device 703 of the sort depicted in FIG. 7C can operate under the control of an operating system, which controls scheduling of tasks and access to system resources. The computing device 703 can be running any operating system configured for any type of computing device, including, for example, a desktop operating system, a mobile device operating system, a tablet operating system, or a smartphone operating system.

The computing device 703 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 703 has sufficient processor power and memory capacity to perform the operations described herein. In some embodiments, the computing device 703 can have different processors, operating systems, and input devices consistent with the device.

In embodiments, the status of one or more machines 104, 702 in the network 105 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 703 in response to the CPU 718 executing an arrangement of instructions contained in main memory 720. Such instructions can be read into main memory 720 from another computer-readable medium, such as the storage device 736. Execution of the arrangement of instructions contained in main memory 720 causes the computing device 703 to perform the illustrative processes described herein. One or more processors in a multi-processing arrangement may also be employed to execute the instructions contained in main memory 720. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system comprising:
one or more processors coupled with memory, the memory storing executable instructions that, when executed by the one or more processors, cause the one or more processors to:
store a plurality of inspection tools in memory, each inspection tool configured to perform a different type of processing action on data packets transmitted across a communications network;
detect a plurality of data packet exchanges between pairs of network devices communicating across a communications network, each of the plurality of data packet exchanges representing a communication session between one network device and another network device across the communication network;
store, using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges;
receive a data packet transmitted from a first network device to a second network device across a communications network;
extract, using the first inspection tool, session information from a header of the data packet;
responsive to determining the extracted session information matches stored session information for a communication session, tag, using the first inspection tool, the data packet with an indication of an active session; and
process, using a second inspection tool of the plurality of inspection tools, the data packet based on the tag of the data packet indicating the active session.

2. The system of claim 1, wherein the instructions cause the one or more processors to: pass, using the first inspection tool, the tagged data packet to the second inspection tool.

3. The system of claim 2, wherein the instructions cause the one or more processors to: pass, using the first inspection tool, the tagged data packet to the second inspection tool by:
generating, using the first inspection tool, the tagged data packet containing the data packet, the data packet tagged in a structured format, and sending the generated tagged data packet to the second inspection tool;
transporting, using the first inspection tool, the data packet to the second inspection tool using a first channel and the indication of the active session using a second channel; or
generating, using the first inspection tool, an updated data packet containing data of the data packet and the indication of the active session and sending the generated tagged data packet to the second inspection tool.

4. The system of claim 1, wherein the instructions cause the one or more processors to:
tag, using the first inspection tool, the data packet with additional metadata regarding the communication session, the additional metadata comprising one or more of:
an indication of whether the communication session has been authenticated,
an indication of whether the data packet is within an expected time-to-live range,
a reputation of the data packet, or
an indication of whether a source or destination of the data packet matches a list of known malicious computing devices.

5. The system of claim 4, wherein the instructions cause the one or more processors to process the tagged data packet by:
processing, using the second inspection tool, the data packet based on the indication of the active session and the additional metadata.

6. The system of claim 4, wherein the instructions cause the one or more processors to:
detect, using the second inspection tool, a network attack based on the tag indicating the active session and the additional metadata.

7. The system of claim 6, wherein the instructions cause the one or more processors to:
inhibit network traffic of data packets of the communication session responsive to detecting the network attack.

8. The system of claim 1, wherein the instructions cause the one or more processors to process the data packet based on the tag of the data packet indicating the active session by:
discarding, using the second inspection tool, the data packet responsive to determining the data packet is tagged with the indication of the active session.

9. The system of claim 1, wherein the instructions cause the one or more processors to:
generate, using the second inspection tool, second metadata regarding the communication session; and
tag, using the second inspection tool, the data packet with the second metadata.

10. The system of claim 9, wherein the instructions cause the one or more processors to:
process, using a third inspection tool of the plurality of inspection tools, the tagged data packet based on the indication of the active session and the second metadata.

11. A system comprising:
one or more processors coupled with memory, the memory storing executable instructions that, when executed by the one or more processors, cause the one or more processors to:
store a plurality of inspection tools in memory, each inspection tool configured to perform a different type of processing action on data packets transmitted across a communications network;
detect a plurality of data packet exchanges between pairs of network devices communicating across a communications network, each of the plurality of data packet exchanges representing a communication session between one network device and another network device across the communication network;
store, using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges;
receive a data packet transmitted from a first network device to a second network device across a communications network;
extract, using the first inspection tool, session information from a header of the data packet;
responsive to determining the extracted session information does not match a stored session information for a communication session, tag, using the first inspection tool, the data packet with an indication that the data packet is not associated with an active session; and
process, using a second inspection tool of the plurality of inspection tools, the data packet based on the tag of the data packet indicating the data packet is not associated with an active session.

12. The system of claim 11, wherein the instructions cause the one or more processors to:
pass, using the first inspection tool, the tagged data packet to the second inspection tool.

13. The system of claim 12, wherein the instructions cause the one or more processors to pass, using the first inspection tool, the tagged data packet to the second inspection tool by:
generating, using the first inspection tool, the tagged data packet containing the data packet, the data packet tagged in a structured format, and sending the generated tagged data packet to the second inspection tool;
transporting, using the first inspection tool, the data packet to the second inspection tool using a first channel and the indication of the active session using a second channel; or
generating, using the first inspection tool, an updated data packet containing data of the data packet and the indication of the active session and sending the generated tagged data packet to the second inspection tool.

14. The system of claim 11, wherein the instructions cause the one or more processors to process the data packet based on the tag of the data packet indicating the data packet is not associated with an active session by:
discarding, using the second inspection tool, the data packet responsive to determining the data packet is tagged with the indication that the data packet is not associated with an active session.

15. A method comprising:
storing, by one or more processors, a plurality of inspection tools in memory, each inspection tool configured to perform a different type of processing action on data packets transmitted across a communications network;
detecting, by the one or more processors, a plurality of data packet exchanges between pairs of network devices communicating across a communications network, each of the plurality of data packet exchanges representing a communication session between one network device and another network device across the communication network;
storing, by the one or more processors using a first inspection tool of the plurality of inspection tools, metadata generated from the plurality of data packet exchanges in respective records corresponding to the different data packet exchanges, each record identifying session information for a different data packet exchange for a communication session, and the metadata comprising indications of active communication sessions of the plurality of data packet exchanges;
receiving, by the one or more processors, a data packet transmitted from a first network device to a second network device across a communications network;
extracting, by the one or more processors using the first inspection tool, session information from a header of the data packet;
responsive to determining the extracted session information matches stored session information for a communication session, tagging, by the one or more processors using the first inspection tool, the data packet with an indication of an active session; and
processing, by the one or more processors using a second inspection tool of the plurality of inspection tools, the data packet based on the tag of the data packet indicating the active session.

16. The method of claim 15, comprising:
passing, by the one or more processors using the first inspection tool, the tagged data packet to the second inspection tool.

17. The method of claim 16, comprising:
passing, by the one or more processors using the first inspection tool, the tagged data packet to the second inspection tool by:
generating, by the one or more processors using the first inspection tool, the tagged data packet containing the data packet, the data packet tagged in a structured format, and sending the generated tagged data packet to the second inspection tool;
transporting, by the one or more processors using the first inspection tool, the data packet to the second inspection tool using a first channel and the indication of the active session using a second channel; or
generating, by the one or more processors using the first inspection tool, an updated data packet containing data of the data packet and the indication of the active session and sending the generated tagged data packet to the second inspection tool.

18. The method of claim 15, comprising:
tagging, by the one or more processors using the first inspection tool, the data packet with additional metadata regarding the communication session, the additional metadata comprising one or more of:
an indication of whether the communication session has been authenticated,
an indication of whether the data packet is within an expected time-to-live range,
a reputation of the data packet, or
an indication of whether a source or destination of the data packet matches a list of known malicious computing devices.

19. The method of claim 18, wherein processing the tagged data packet comprises:
processing, by the one or more processors using the second inspection tool, the data packet based on the indication of the active session and the additional metadata.

20. The method of claim 18, comprising:
detecting, by the one or more processors using the second inspection tool, a network attack based on the tag indicating the active session and the additional metadata.
